(19) United States
(12) Patent Application Publication
(10) Pub. No.: US 2011/0176295 A1
(43) Pub. Date: Jul. 21, 2011

(54) LAMP

(75) Inventors: Shu-Mei Chang, Hsin-Chu (TW); Chien-Tsai Chueh, Hsin-Chu (TW)

(73) Assignee: YOUNG LIGHTING TECHNOLOGY CORPORATION, Hsin-Chu (TW)

(21) Appl. No.: 12/687,886

(22) Filed: Jan. 15, 2010

(51) Int. Cl. F21S 8/00

(52) U.S. Cl. 362/147

(57) ABSTRACT

A lamp suitable for being mounted to a ceiling having an opening is provided. The lamp includes a plane light source and a mounting module including a plurality of bases, a plurality of clipping elements and a plurality of first elastic elements. Each of the bases is slidably disposed on the plane light source, wherein the bases slide to a plurality of specific positions on the plane light source respectively and pass through the opening when the plane light source is leaned against the ceiling. The clipping elements are movably connected to the bases respectively. Each of the first elastic elements is connected with the corresponding base and the corresponding clipping element, wherein the ceiling is suitable for being clipped between the clipping elements and the plane light source by elastic force of the first elastic elements.

### BACKGROUND OF THE INVENTION

1. Field of the Invention

The present invention generally relates to a light emitting device. More particularly, the present invention relates to a lamp.

2. Description of Related Art

Fluorescent lamps and incandescent lamps are commonly-used lamps. As the light emitting efficiency of light emitting diode (LED) continues to advance, LED gradually substitutes fluorescent lamps and incandescent lamps to be used for illumination. Compared with the traditional bulbs, LED has great advantages, such as smaller size, longer lifespan, drivable by low voltage/current, non-fragile, mercury-free, favorable light emitting efficiency (power saving), and so forth.

A lamp for interior illumination is usually fixed to the fixing ends (ceiling, for example) in buildings by the force of the torsion springs provided with the lamp. Particularly, the lamp is fixed to, for example, a ceiling having an opening, wherein the torsion springs are located at the periphery of the opening, such that the ceiling is capable of being clipping between each of the torsion spring and a shell of the lamp. Generally, the torsion springs are fixed at specific positions on the lamp, so that the lamp is only suitable for mounted to a ceiling having an opening with specific size.

### SUMMARY OF THE INVENTION

The present invention is to provide a lamp, suitable for being mounted to openings with different sizes respectively.

As embodied and broadly described herein, the present invention provides a lamp suitable for being mounted to a ceiling. The ceiling has an opening. The lamp includes a plane light source and a mounting module. The mounting module includes a plurality of bases, a plurality of clipping elements and a plurality of first elastic elements. Each of the bases is slidably disposed on the plane light source, wherein the bases slide to a plurality of specific positions on the plane light source respectively and pass through the opening when the plane light source is leaned against the ceiling. The clipping elements are movably connected to the bases respectively. Each of the first elastic elements is connected with the corresponding base and the corresponding clipping element, wherein the ceiling is suitable for being clipped between the clipping elements and the plane light source by elastic force of the first elastic elements.

In summary, in the embodiment, the bases are slidably disposed on the plane light source, the clipping elements are movably connected to the bases respectively, and each of the first elastic elements is connected with the corresponding base and the corresponding clipping element. The clipping elements and the first elastic elements are capable of moving to specific positions on the plane light source, such that a ceiling having an opening with various sizes is suitable for being clipped between the clipping elements and the plane light source by elastic force of the first elastic elements. Thus, the applicability of the lamp is increased.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view showing a lamp according to one embodiment of the present invention.

FIG. 1B is a schematic view showing partial structure of the lamp of FIG. 1A.

FIG. 1C is a cross-section view showing the lamp of FIG. 1A.

FIG. 2A is a schematic view showing the bases of FIG. 1 sliding relatively to the plane light source.

FIG. 2B is a schematic view showing partial structure of the lamp of FIG. 2A.

FIG. 2C is a cross-section view showing the lamp of FIG. 2A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

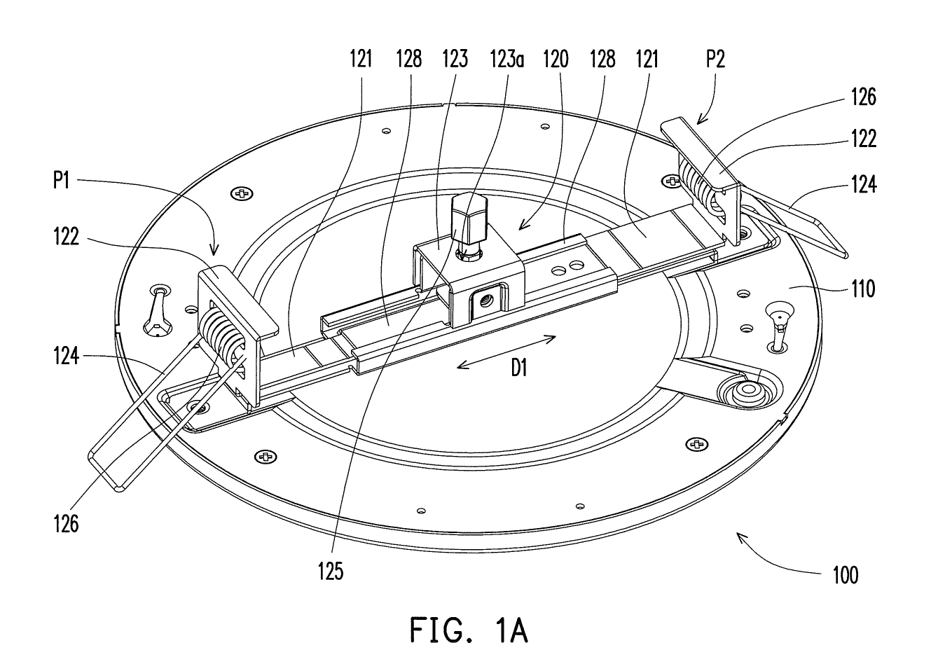

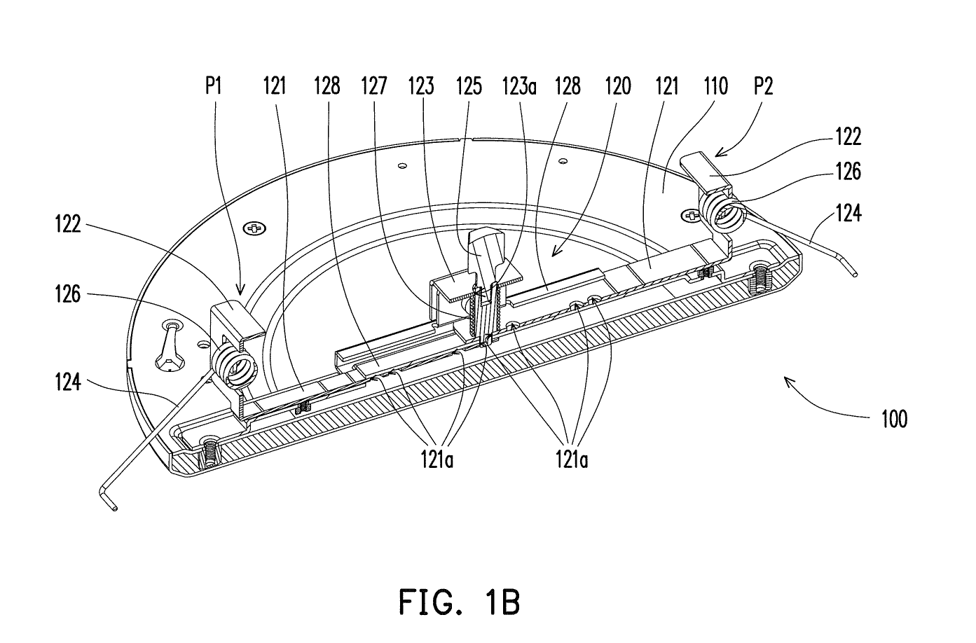

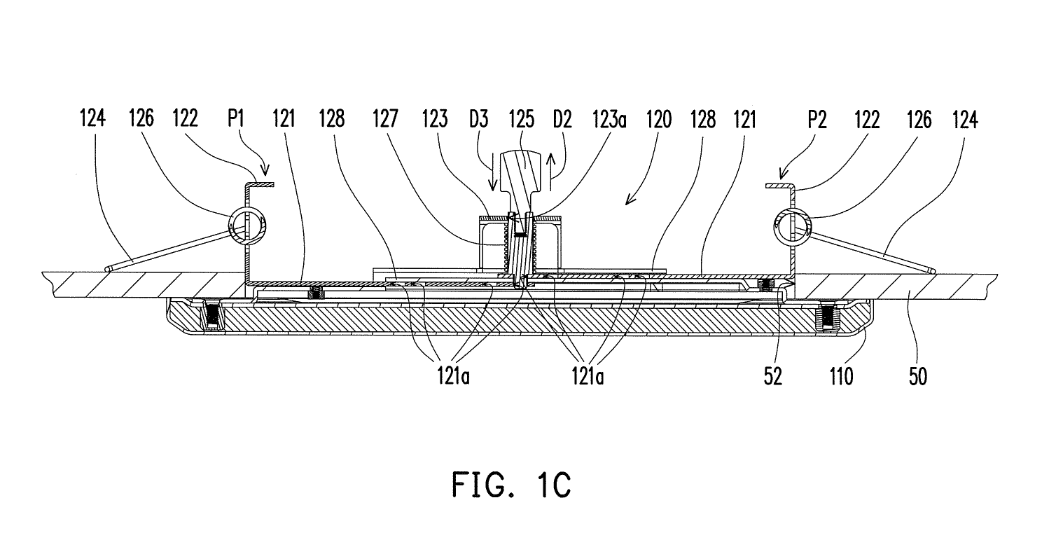

FIG. 1A is a schematic view showing a lamp according to one embodiment of the present invention. FIG. 1B is a schematic view showing partial structure of the lamp of FIG. 1A. FIG. 1C is a cross-section view showing the lamp of FIG. 1A. Referring to FIG. 1A to FIG. 1C, a lamp 100 of this embodiment includes a plane light source 110 and a mounting module 120. The mounting module 120 includes a plurality of bases 122 (two shown), a plurality of clipping elements 124 (two shown) and a plurality of first elastic elements 126 (two shown). The plane light source 110 of this embodiment is, for example, a light emitting diode (LED) light source.

Each of the bases 122 is slidably disposed on the plane light source 110 along the direction D1 shown in FIG. 1A, wherein the bases 122 slide to specific positions P1 and P2 on the plane light source 110 respectively and pass through an opening 52 of a ceiling 50 (shown in FIG. 1C) when the plane light source 110 is leaned against the ceiling 50. The clipping elements 124 are movably connected to the bases 122 respectively. Each of the first elastic elements 126 is connected with the corresponding base 122 and the corresponding clipping element 124, wherein the ceiling 50 is suitable for being clipped between the clipping elements 124 and the plane light source 110 by elastic force of the first elastic elements 124. In this embodiment, each of the first elastic elements 126 and the corresponding clipping element 124 form a torsion spring.

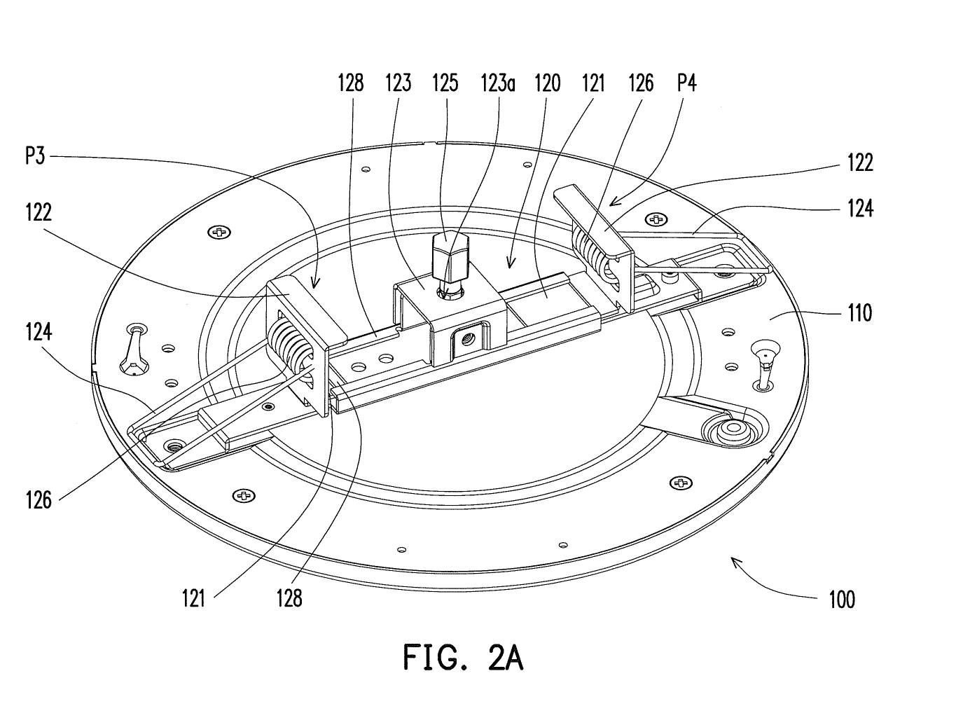

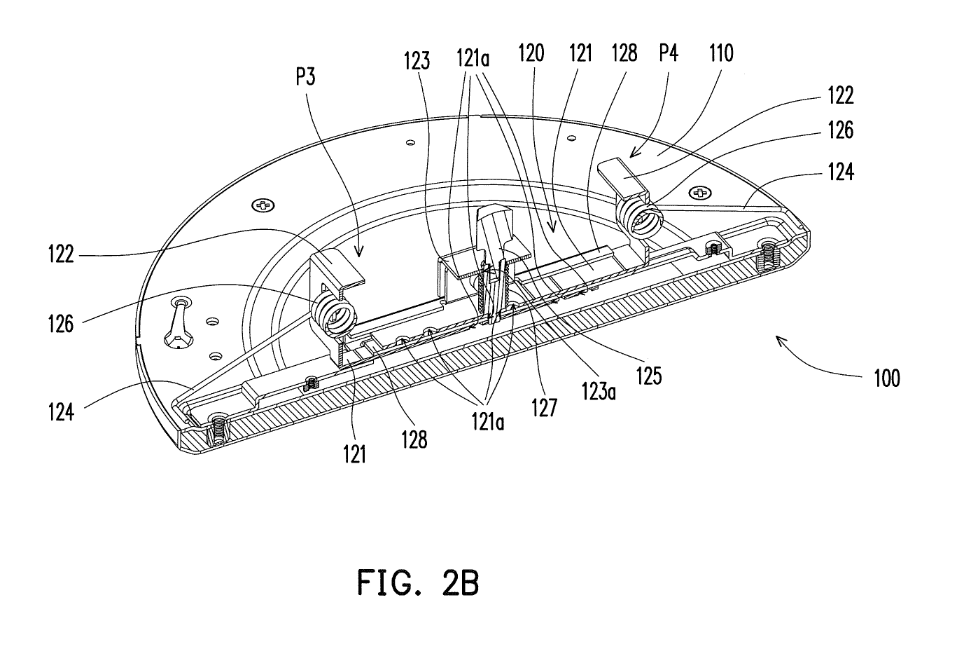

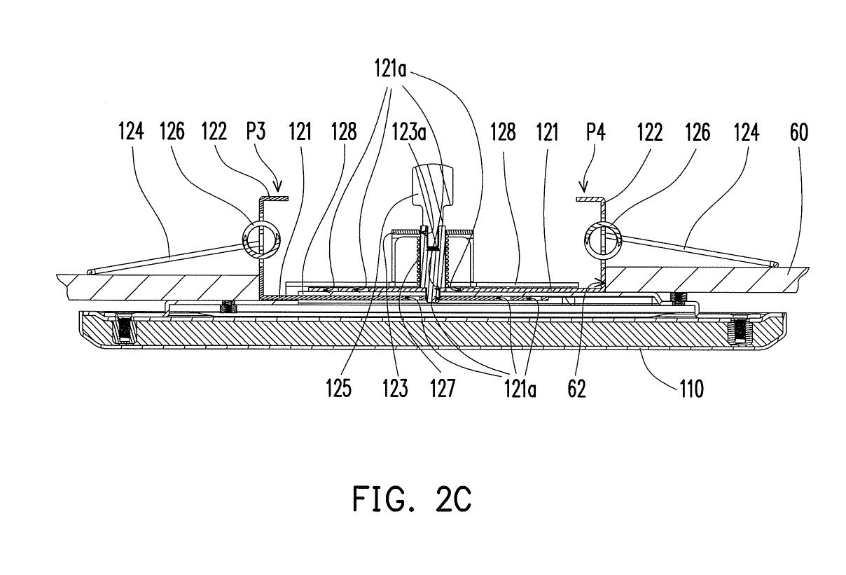

FIG. 2A is a schematic view showing the bases of FIG. 1 sliding relatively to the plane light source. FIG. 2B is a schematic view showing partial structure of the lamp of FIG. 2A. FIG. 2C is a cross-section view showing the lamp of FIG. 2A. The bases 122, the clipping elements 124 and the first elastic elements 126 are capable of sliding relatively to the plane light source 110 from specific positions P1 and P2 (as shown in FIG. 1A to FIG. 1C) to specific positions P3 and P4 (as shown in FIG. 2A to FIG. 2C), such that a ceiling 60 with an opening 62 (shown in FIG. 2C) smaller than the opening 52 shown in FIG. 1C is capable of being clipping between the clipping elements 124 and the plane light source 110 by elastic force of the first elastic elements 126.

Thus, the clipping elements 124 are capable of being sliding to specific positions, such as specific positions P1 and P2 shown in FIG. 1A to FIG. 1C or specific positions P3 and P4 shown in FIG. 2A to FIG. 2C, to clip a ceiling with an opening having specific size. In other words, the lamp 100 of this embodiment is suitable for being mounted to openings (such as opening 52 shown in FIG. 1C or opening 62 shown in FIG. 2C) having different sizes by sliding the clipping elements 124 to different positions on the plane light source 110.

Particularly, the mounting module 120 further includes a plurality of sliding tracks 128 (two shown) and a plurality of sliding blocks 121 (two shown). The sliding tracks 128 are fixed to the plane light source 110. The sliding blocks 121 are fixed to the bases 122 respectively and slidably disposed at the sliding tracks 128 along the direction D1 shown in FIG. 1A respectively. Each of the sliding blocks 121 is capable of sliding relatively to the corresponding sliding track 128 to drive the corresponding base 122, the corresponding clipping element 124 and the corresponding first elastic element 126 to slide relatively to the plane light source 110. In this embodiment, each of the bases 122 and the corresponding sliding block 121 are, for example, formed as an integrative unit.

In addition, referring to FIG. 1B and FIG. 1C, each of the sliding blocks 121 has at least one positioning hole 121a (four shown) and the mounting module 120 further includes a guiding element 123, a positioning element 125 and a second elastic element 127. The guiding element 123 is fixed to the sliding tracks 128 and having a guiding hole 123a. The positioning element 125 is pierced through the guiding hole 123a and two positioning holes 121a belong to the two sliding blocks 121 respectively for fixing the relative positions between the sliding blocks 121 and the sliding tracks 128. The second elastic element 127 is connected with the guiding element 123 and the positioning element 125, wherein the positioning element 125 is capable of resisting elastic force of the second elastic element 127 to slide along the guiding hole 123a for being separated from the sliding blocks 121.

In this way, the sliding blocks 121 are capable of being positioned at specific positions as shown in FIG. 1A to FIG. 1C or shown in FIG. 2A to FIG. 2C by structural interference between the positioning element 125 and the sliding blocks 121. Besides, when a user resists elastic force of the second elastic element 127 to pull the positioning element 125 along the direction D2 shown in FIG. 1C for driving the positioning element 125 to be separated from the sliding blocks 121 (the separating condition is not shown in Figs), the user can apply force to the sliding blocks 121 to drive the sliding blocks 121 to slide relatively to the sliding tracks 128. After the sliding blocks 121 are moved to suitable positions, the user can release the positioning element 125 and the positioning element 125 will move along the direction D3 shown in FIG. 1C by elastic force of the second elastic element 127, such that the positioning element 125 is again pierced through two positioning holes 121a belong to the two sliding blocks 121 respectively for fixing the relative positions between the sliding blocks 121 and the sliding tracks 128. Thus, it is convenient to adjust the positions of the sliding blocks 121 on the plane light source 110 and thereafter fix the sliding blocks 121 on the plane light source 110.

In this embodiment, the second elastic element 127 is, for example, a coil spring, and the positioning element is, for example, composed of a screw and a positioning pin as shown in drawings. Furthermore, the sliding tracks 128 of this embodiment are stacked on each other, such that the plane light source 110 has larger disposing area.

To sum up, in the embodiment, the bases are slidably disposed on the plane light source, the clipping elements are movably connected to the bases respectively, and each of the first elastic elements is connected with the corresponding base and the corresponding clipping element. The clipping elements and the first elastic elements are capable of moving to specific positions on the plane light source, such that a ceiling having an opening with specific size is suitable for being clipped between the clipping elements and the plane light source by elastic force of the first elastic elements. Thus, the applicability of the lamp is increased. In addition, the sliding blocks capable of driving the bases are capable of being positioned at specific positions by the positioning element. When the positioning element is separated from the sliding blocks, the positions of the sliding blocks are adjusted, and the positioning element is capable of recovering to position the sliding blocks by elastic force of the second elastic element. Thus, the lamp is convenient to be adjusted and assembled.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A lamp suitable for being mounted to a ceiling, the ceiling has an opening, the lamp comprising:
a plane light source; and
a mounting module, comprising:
a plurality of bases, each of the bases slidably disposed on the plane light source, wherein the bases slide to a plurality of specific positions on the plane light source respectively and pass through the opening when the plane light source is leaned against the ceiling;
a plurality of clipping elements, movably connected to the bases respectively; and
a plurality of first elastic elements, each of the first elastic elements connected with the corresponding base and the corresponding clipping element, wherein the ceiling is suitable for being clipped between the clipping elements and the plane light source by elastic force of the first elastic elements.

2. The lamp as claimed in claim 1, wherein the mounting module further comprising:
a plurality of sliding tracks, fixed to the plane light source; and
a plurality of sliding blocks, fixed to the bases respectively and coupled with the sliding tracks respectively.

3. The lamp as claimed in claim 2, wherein each of the bases and the corresponding sliding block are formed as an integrative unit.

4. The lamp as claimed in claim 2, wherein each of the sliding blocks has at least one positioning hole and the mounting module further comprising:
a guiding element, fixed to the sliding tracks and having a guiding hole;
a positioning element, pierced through the guiding hole and the positioning holes for fixing the relative positions between the sliding blocks and the sliding tracks; and
a second elastic element, connected with the guiding element and the positioning element, wherein the positioning element is capable of resisting elastic force of the second elastic element to slide along the guiding hole for being separated from the sliding blocks.

5. The lamp as claimed in claim 4, wherein the second elastic element is a coil spring.

6. The lamp as claimed in claim 2, wherein the sliding tracks are stacked on each other.

7. The lamp as claimed in claim 1, wherein each of the first elastic elements and the corresponding clipping element form a torsion spring.
